(19) United States
(12) Patent Application Publication
(10) Pub. No.: US 2019/0084287 A1
(43) Pub. Date: Mar. 21, 2019

(54) CORRUGATED CARDBOARD PLANT

(71) Applicant: BHS Corrugated Maschinen- und Anlagenbau GmbH, Weiherhammer (DE)

(72) Inventors: Berthold AUMÜLLER, Weiden (DE); Helmut KRAUS, Wackersdorf (DE); Maximilian MARK, Tirschenreuth (DE); Norbert STÄDELE, Parkstein (DE)

(21) Appl. No.: 16/134,186

(22) Filed: Sep. 18, 2018

(30) Foreign Application Priority Data
Sep. 21, 2017 (DE) 10 2017 216 720.3

(51) Int. Cl. B32B 39/00; B32B 38/00; B32B 37/12; B32B 37/20

(52) U.S. Cl. CPC B32B 39/00; B32B 38/145; B32B 2317/127; B32B 37/20; B32B 37/12

(57) ABSTRACT

The invention relates to a corrugated cardboard plant for producing corrugated cardboard. The corrugated cardboard plant comprises at least one device for producing a respective corrugated cardboard web laminated on one side from a respective cover web and a respective material web; a lamination web dispensing device for dispensing a lamination web; a lamination web printing assembly, disposed downstream of the lamination web dispensing device, for imprinting the lamination web; and a device, disposed downstream of the lamination web printing assembly, for producing a corrugated cardboard web laminated on two sides from the at least one corrugated cardboard web laminated on one side and the lamination web.

### CROSS-REFERENCE TO RELATED APPLICATIONS

This application claims priority of German Patent Application Serial No. DE 10 2017 216 720.3, filed on Sep. 21, 2017, pursuant to 35 U.S.C. 119(a)-(d), the content of which is incorporated herein by reference in its entirety as if fully set forth herein.

### FIELD OF THE INVENTION

The invention relates to a corrugated cardboard plant and to a method for producing corrugated cardboard.

### BACKGROUND OF THE INVENTION

Corrugated cardboard plants having printing assemblies for imprinting webs are generally known from the prior art by way of obvious prior use. The quality of the imprint by the printing assemblies is however unsatisfactory in many instances.

### SUMMARY OF THE INVENTION

The invention is based on the object of achieving a corrugated cardboard plant having a printing assembly which requires a comparatively small space. Furthermore, the printing quality and the corrugated cardboard quality, respectively, are to be particularly high. A respective production method is likewise to be provided.

This object is achieved according to the invention by a corrugated cardboard plant for producing corrugated cardboard, comprising at least one device for producing a respective corrugated cardboard web laminated on one side from a respective cover web and a respective material web; a lamination web dispensing device for dispensing a lamination web; a lamination web printing assembly, disposed downstream of the lamination web dispensing device, for imprinting the lamination web; and a device, disposed downstream of the lamination web printing assembly, for producing a corrugated cardboard web laminated on two sides from the at least one corrugated cardboard web laminated on one side and the lamination web.

Furthermore, this object is achieved according to the invention by a method for producing corrugated cardboard, comprising the step of applying glue by means of a gluing unit to free tips of at least one corrugated cardboard web laminated on one side for connecting the latter in a glued manner to a further web for forming a corrugated cardboard web laminated on two sides, wherein the glue permits processing temperatures of below 70° C., said temperatures favourably being present at least on the at least one corrugated cardboard web laminated on one side and/or on the lamination web.

The core concept of the corrugated cardboard plant according to the invention lies in that the lamination web printing assembly is disposed between a lamination web dispensing device and a device for producing a corrugated cardboard web laminated on two sides or both sides, respectively. The lamination web printing assembly in operation imprints the conveyed, in particular continuous, lamination web on at least one print side. The lamination web preferably is, or remains, respectively, a smooth non-corrugated web. The corrugated cardboard web laminated on two sides has at least three plies, preferably three plies, five plies, or seven plies.

The lamination web printing assembly is advantageously configured as a digital printing assembly, in particular an ink jet printing assembly. Said lamination web printing assembly is preferably retro-fittable. Alternatively, other known printing assemblies can be used.

The lamination web printing assembly is in particular capable of imprinting at least one alphabetic letter, a numeral, or any other sign, a graph and/or a photograph on the lamination web. A paint or printing ink, respectively, is favourably used to this end. It is advantageous for the lamination web printing assembly to be capable of multi-colour printing.

The lamination web printing assembly favourably has a plurality of printing heads which are disposed in a cascading manner in the transverse direction of the lamination web. The lamination web printing assembly preferably has a plurality of rows of printing heads that are disposed behind one another. It is advantageous for the lamination web to be imprinted, when imprinted in the lamination web printing assembly, to be guided over a printing cylinder or a central cylinder, respectively. The printing cylinder preferably extends horizontally and perpendicularly to a conveying direction of the lamination web.

The device for producing an in particular continuous corrugated cardboard web laminated on one side favourably comprises a grooving installation for grooving a material web to be corrugated, while forming a corrugated web.

It is advantageous for the device for producing a corrugated cardboard web laminated on one side to have a glue application installation for gluing the corrugated web.

A cover web dispensing device favourably dispenses the cover web. It is advantageous for the cover web dispensing device to be configured as a splicing device for providing a continuous cover web.

It is expedient for the device for producing a corrugated cardboard web laminated on one side to moreover comprise a contact pressure installation for pressing the cover web against the corrugated web provided with glue.

A material web dispensing device preferably dispenses the material web. The material web dispensing device is favourably configured as a splicing device for providing a continuous material web.

The lamination web dispensing device is preferably configured as a splicing device for providing a continuous lamination web.

The device for producing a corrugated cardboard web laminated on two sides favourably connects the at least one corrugated cardboard web laminated on one side to the lamination web. Said device for producing a corrugated cardboard web laminated on two sides favourably has at least one compression section, or at least one compression gap, respectively, which is smaller than 15 metres, preferably smaller than 10 metres. The device for producing a corrugated cardboard web laminated on two sides favourably comprises at least two in particular drivable compression rollers or compression belts, respectively, which are disposed in pairs and disposed so as to be mutually adjacent. The at least one corrugated cardboard web laminated on one side and the lamination web are guided through the compression section and are pressed against one another therein. Glue for connecting the webs in a glued manner is preferably located between said webs.

The terms “disposed upstream”, “disposed downstream”, “upstream”, “downstream”, “behind one another” or the like used here refer in particular to the conveying direction of the respective conveyed web.

The processing temperatures of the glue of below 70° C. as claimed by the method according to the invention for producing corrugated cardboard lead to particularly little energy being required in order for the corrugated cardboard to be produced. Furthermore, the webs to be glued, or to be connected, respectively, are treated in a gentle manner. The glue has a comparatively low bonding temperature or curing temperature, respectively.

Bonding or curing, respectively, of the glue is performed in particular when the latter is applied to the at least one corrugated cardboard web laminated on one side, or immediately thereafter, respectively, the glue receptacle region of said corrugated cardboard web preferably having a temperature which is sufficient for the glue to bond, cure, or dry, respectively. Regions of the glue or of glue lines, respectively, herein experience favourably temperatures of below 70° C. both when the glue is applied as well as thereafter. The processing temperatures are favourably present on the at least one corrugated cardboard web laminated on one side. In particular, the lamination web is heated in a corresponding manner by the lamination web printing assembly. Respective heating of the lamination web is performed, for example, by at least one imprint drying device of the lamination web printing assembly that is assigned to the lamination web.

The corrugated cardboard plant configured such that the at least one device for producing a respective corrugated cardboard web laminated on one side, and the lamination web dispensing device, and the lamination web printing assembly are disposed in one row, in particular in a conveying direction of the corrugated cardboard plant, is configured in a particularly simple manner. The at least one device for producing a respective corrugated cardboard web laminated on one side, and the lamination web dispensing device, and the lamination web printing assembly, are favourably disposed behind one another, or so as to be disposed downstream of one another, respectively. A corrugated cardboard plant of this type transversely to a conveying direction thus has an extremely small width. The lamination web printing assembly is in particular located within the actual corrugated cardboard plant.

The corrugated cardboard plant configured such that the lamination web printing assembly is disposed below a bridge for guiding the at least one corrugated cardboard web laminated on one side in a direction towards the device for producing a corrugated cardboard web laminated on two sides has a comparatively minor requirement in terms of space. The length of said corrugated cardboard plant is in particular comparatively short. Furthermore, the lamination web printing assembly is thus not or barely exposed to any external disturbing influences such as vibrations that are generated by the device for producing a corrugated cardboard web laminated on one side.

The bridge of the corrugated cardboard plant favourably has a bridge height level of at least 4 metres in relation to a floor or a hard surface, respectively. Said bridge, at least in a manner adjacent to the lamination web printing assembly, preferably has a bridge portion that is elevated on a frame. The bridge overall favourably has a length which is smaller than 35 metres.

The at least one shield assembly of the bridge for reducing a drying-up of the at least one corrugated cardboard web laminated on one side that is guided in the bridge at least in regions favourably extends along the bridge in a conveying direction of the at least one corrugated cardboard web laminated on one side that is conveyed there. Said at least one shield assembly in the conveying direction preferably extends across at least 10 metres. Said at least one shield assembly is preferably formed from a metallic material or an insulation material, respectively.

The at least one shield assembly comprising at least one side wall and/or cover is preferably closed off laterally and towards the top. Said at least one shield assembly according to the dependent claim 5 is preferably embodied as a housing or an encapsulation, respectively. This particularly effectively prevents a drying-up of the at least one corrugated cardboard web laminated on one side in the bridge.

The assembly configured such that a bridge has a web run correction assembly for correcting a web run of the at least one corrugated cardboard web laminated on one side in the bridge, wherein the web run correction assembly has a smaller horizontal spacing from the device for producing a corrugated cardboard web laminated on two sides than the lamination web printing assembly, leads to an extremely high corrugated cardboard quality. In particular, the at least one corrugated cardboard web laminated on one side in terms of the position or location, respectively, thereof is thus capable of being adapted or matched, respectively, to the lamination web.

The design embodiment comprising a reversing assembly for directing a print side of the lamination web downwards, wherein the reversing assembly is disposed downstream of the lamination web printing assembly and upstream of the device for producing a corrugated cardboard web laminated on two sides, enables a simple imprinting of the lamination web. The lamination web in the lamination web printing assembly is in particular capable of being imprinted from above. The reversing assembly is in particular disposed downstream of a lamination web printing device of the lamination web printing assembly.

The reversing assembly having at least one vertically running reversing bar which preferably is horizontally displaceable for correcting a web run of the lamination web permits a particularly simple correction of the web run of the lamination web, or a lateral deflection of the latter, respectively. This once more leads to a particularly high corrugated cardboard quality.

A design embodiment without a reversing assembly is alternatively possible.

The at least one re-humidification device for re-humidifying the lamination web, wherein the re-humidification device is disposed downstream of the lamination web printing assembly and upstream of the device for producing a corrugated cardboard web laminated on two sides, leads to an extremely positive planar positioning of the lamination web and to particularly good adhesive bonding of the lamination web to an adjacent corrugated cardboard web laminated on one side in the device for producing a corrugated cardboard web laminated on two sides. The at least one re-humidification device ensures in particular a re-humidification of at least 5 ml/m².

The corrugated cardboard plant comprising a gluing unit for gluing the at least one corrugated cardboard web laminated on one side with glue, wherein the gluing unit is disposed downstream of the lamination web printing assembly and, in particular so as to be directly, adjacent to the lamination web printing assembly, in particular in such a manner that the lamination web printing assembly heats the lamination web in such a manner that the glue applied by the gluing unit bonds, has a comparatively minor requirement in terms of space. Furthermore, the requirement in terms of energy of said corrugated cardboard plant is comparatively minor. In particular, a pre-heating assembly for pre-heating the at least one corrugated cardboard web laminated on one side and/or the lamination web, in particular directly upstream of the device for producing a corrugated cardboard web laminated on two sides, or of the gluing unit, respectively, can thus be dispensed with. This can in particular be traced back to a particularly short section being present between the imprint by the lamination web printing device and the device for producing a corrugated cardboard web laminated on two sides. A spacing between the lamination web printing assembly, or the lamination web printing device, respectively, and the gluing unit is favourably smaller than 5 m. The lamination web printing assembly has at least one dedicated heating element for heating the lamination web, for example. The gluing unit can also be the subject matter of an independent inventive subject matter.

The glue used in the gluing unit, which permits processing temperatures of below 70° C., is capable of being processed already at comparatively low temperatures, this also leading to lower operating costs.

The lamination web printing assembly, or the at least one lamination web printing device, respectively, configured such as to heat the lamination web in such a manner that said lamination web in the device for producing a corrugated cardboard web laminated on two sides is connectable in a glued manner to the adjacent corrugated cardboard web laminated on one side when imprinting favourably heats the lamination web at least in portions to a maximum of 120° C., more preferably to 50° C. to 70° C. Heating in this manner is favourably performed when drying the imprint.

The at least one heat protection assembly for protecting a lamination printing device of the lamination web printing assembly against thermal input favourably comprises a heat protection material or a heat insulation material, respectively. Said at least one heat protection assembly preferably extends between the lamination web printing device and a drying device of the lamination web printing assembly. This leads to a high printing quality.

The design embodiment comprising a lamination web run correction installation for correcting a web run of the lamination web again leads to an extremely high corrugated cardboard quality. In particular, a particularly good adaptation or matching, respectively, of the lamination web to the at least one corrugated cardboard web laminated on one side is thus possible. To this end, the lamination web is favourably laterally deflectable. The lamination web run correction installation is preferably disposed upstream of the device for producing a corrugated cardboard web laminated on two sides, or of a gluing unit, respectively. Said lamination web run correction installation is favourably disposed downstream of a lamination web printing device.

The web run correction installation comprising at least one pivotable pivot roller is configured in a particularly simple manner. The at least one pivot roller is favourably embodied as a cambered roller. Said at least one pivot roller preferably extends across a width of the lamination web. The lamination web preferably bears circumferentially on the at least one pivot roller. The at least one pivot roller is preferably deflectable in relation to the lamination web in order for the web run of the lamination web to be influenced.

The design embodiments discussed above can also relate to preferred refinements of the method according to the invention for producing corrugated cardboard.

Two preferred embodiments of the invention will be described in an exemplary manner hereunder with reference to the appended drawing.

### BRIEF DESCRIPTION OF THE DRAWING

FIG. 1 shows a schematic lateral view of a corrugated cardboard plant according to the invention;

FIG. 2 shows an enlarged fragment from FIG. 1, visualizing in particular the lamination web printing assembly and components of the corrugated cardboard plant that are adjacent to said lamination web printing assembly;

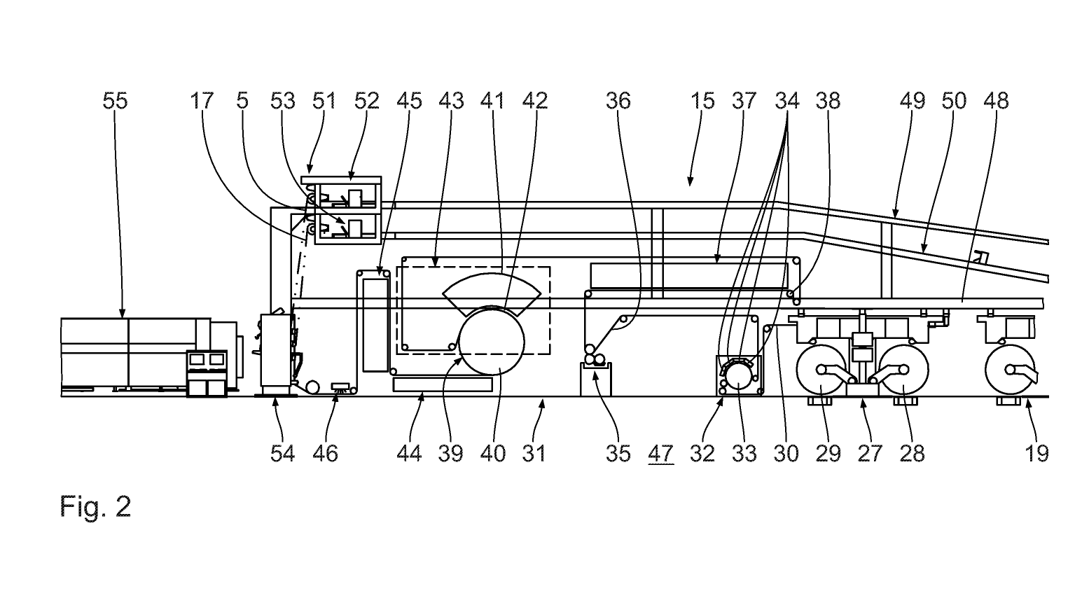

FIG. 3 shows a lateral view corresponding to that of FIG. 1 of a corrugated cardboard plant according to the invention and according to a second embodiment; and

FIG. 4 shows a fragment corresponding to that of FIG. 2 of the corrugated cardboard plant according to FIG. 3.

### DESCRIPTION OF THE PREFERRED EMBODIMENTS

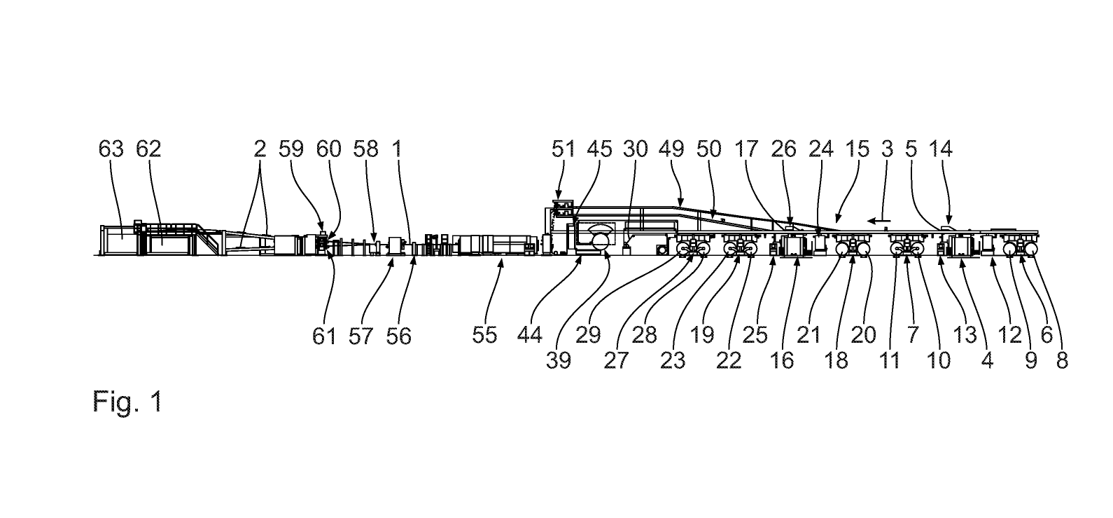

A corrugated cardboard plant shown in its entirety in FIG. 1 is capable of producing a continuous five-ply corrugated cardboard web 1, or five-ply corrugated cardboard sheets, 2, respectively. The corrugated cardboard plant overall is embodied in a longitudinal manner. Said corrugated cardboard plant extends substantially in a longitudinal direction or conveying direction 3, respectively.

The corrugated cardboard plant comprises a first device 4 for producing a first corrugated cardboard web 5 laminated on one side.

A first cover web splicing device 6 and a first material web splicing device 7 are disposed upstream of the first device 4 for producing a first corrugated cardboard web 5 laminated on one side.

The first cover web splicing device 6 comprises a first unwinding unit for unwinding a finite first cover web from a first cover web roll 8, and a second unwinding unit for unwinding a finite second cover web from a second cover web roll 9. The finite first cover web and the finite second cover web are connected to one another in the first cover web splicing device 6 in order for a continuous first cover web to be provided.

The first material web splicing device 7 is configured in a manner corresponding to that of the first cover web splicing device 6. Said first material web splicing device 7 comprises a third unwinding unit for unwinding a finite first material web from a first material web roll 10, and a fourth unwinding unit for unwinding a finite second material web from a second material web roll 11. The finite first material web and the finite second material web are connected to one another in the first material web splicing device 7 in order for a continuous first material web to be provided.

The continuous first cover web is fed to the first device 4 for producing a first corrugated cardboard web 5 laminated on one side by way of a first heating assembly 12, while the continuous first material web is fed to the first device 4 for producing a first corrugated cardboard web 5 laminated on one side by way of a first deflection assembly 13.

The first device 4 for producing a first corrugated cardboard web 5 laminated on one side, for generating a continuous first corrugated web having a corrugation from the continuous first material web, comprises a rotatably mounted first grooving roller and a rotatably mounted second grooving roller. The grooving rollers configure a first roller gap for guiding through and grooving the continuous first material web. Said grooving rollers conjointly form a first grooving assembly.

In order for the continuous first corrugated web to be connected to the continuous first cover web so as to form the first corrugated cardboard web 5 laminated on one side, the first device 4 for producing a first corrugated cardboard web 5 laminated on one side has a first glue application installation which comprises a first glue metering roller, a first glue container, and a first glue application roller. The first glue application roller, conjointly with the first grooving roller, configures a first gap for guiding through and gluing the continuous first corrugated web. The glue located in the first glue container is applied to tips of the corrugation of the continuous first corrugated web by way of the first glue application roller. The first glue metering roller bears on the first glue application roller and serves for configuring a uniform glue layer on the first glue application roller.

The continuous first cover web in the first device 4 for producing a first corrugated cardboard web 5 laminated on one side is subsequently joined to the continuous first corrugated web provided with glue from the first glue container.

In order for the continuous first cover web to be pressed against the continuous first corrugated web provided with glue, the latter web in turn in regions bearing on the first grooving roller, the first device 4 for producing a first corrugated cardboard web 5 laminated on one side has a first contact pressure module. The first contact pressure module is favourably embodied as a contact pressure web module. Said first contact pressure module is disposed above the first grooving roller. The first contact pressure module has two first deflection rollers and a continuous first contact pressure belt which is guided around the two first deflection rollers.

The first grooving roller in regions engages from below into a space that is present between the two first deflection rollers, on account of which the first contact pressure belt is deflected by the first grooving roller. The first contact pressure belt presses against the continuous first cover web which in turn is pressed against the continuous first corrugated web that is provided with glue and bears on the first grooving roller.

In order for the first corrugated cardboard web 5 laminated on one side to be further conveyed, said first corrugated cardboard web 5 laminated on one side is fed to a bridge 15 of the corrugated cardboard plant by way of a first elevated transportation installation 14. The bridge 15 can also serve for the intermediate storage and buffer storage of the first corrugated cardboard web 5 laminated on one side.

The corrugated cardboard plant moreover comprises a second device 16 for producing a second corrugated cardboard web 17 laminated on one side.

A second cover web splicing device 18 and a second material web splicing device 19 are disposed upstream of the second device 16 for producing a second corrugated cardboard web 17 laminated on one side.

The second cover web splicing device 18 is configured in a manner corresponding to that of the first cover web splicing device 6. Said second cover web splicing device 18 comprises a fifth unwinding unit for unwinding a finite third cover web from a third cover web roll 20, and a sixth unwinding unit for unwinding a finite fourth cover web from a fourth cover web roll 21. The finite third cover web and fourth cover web are connected to one another in the second cover web splicing device 18 in order for a continuous second cover web to be provided.

The second material web splicing device 19 is configured like the first material web splicing device 7. Said second material web splicing device 19 comprises a seventh unwinding unit for unwinding a finite third material web from a third material web roll 22, and an eighth unwinding unit for unwinding a finite fourth material web from a fourth material web roll 23. The finite third material web and fourth material web are connected to one another in the second material web splicing device 19 in order for a continuous second material web to be provided.

The continuous second cover web is fed to the second device 16 for producing a second corrugated cardboard web 17 laminated on one side by way of a second heating assembly 24, while the continuous second material web is fed to the second device 16 for producing a second corrugated cardboard web 17 laminated on one side by way of a second deflection assembly.

The second device 16 for producing a second corrugated cardboard web 17 laminated on one side is configured in a manner corresponding to that of the first device 4 for producing a first corrugated cardboard web 5 laminated on one side. Said second device 16 for producing a second corrugated cardboard web 17 laminated on one side, for generating a continuous second corrugated web having a corrugation from the continuous second material web, comprises a rotatably mounted third grooving roller and a rotatably mounted fourth grooving roller. The grooving rollers configure a second roller gap for guiding through and grooving the continuous second material web. Said grooving rollers conjointly form a second grooving assembly.

In order for the continuous second corrugated web to be connected to the continuous second cover web so as to form the second corrugated cardboard web 17 laminated on one side, the second device 16 for producing a second corrugated cardboard web 17 laminated on one side has a second glue application installation which comprises a second glue metering roller, a second glue container, and a second glue application roller. The second glue application roller, conjointly with the third grooving roller, configures a second gap for guiding through and gluing the continuous second corrugated web. The glue located in the second glue container is applied to tips of the corrugation of the continuous second corrugated web by way of the second glue application roller. The second glue metering roller bears on the second glue application roller and serves for configuring a uniform glue layer on the second glue application roller.

The continuous second cover web in the second device 16 for producing a second corrugated cardboard web 17 laminated on one side is subsequently joined to the continuous second corrugated web provided with glue from the second glue container.

In order for the continuous second cover web to be pressed against the continuous second corrugated web provided with glue, the latter web in turn in regions bearing on the third grooving roller, the second device 16 for producing a second corrugated cardboard web 17 laminated on one side has a second contact pressure module. The second contact pressure module is favourably embodied as a contact pressure belt module. Said second contact pressure module is disposed above the third grooving roller. The second contact pressure module has two second deflection rollers and a continuous second contact pressure belt which is guided around the two second deflection rollers.

The third grooving roller in regions engages from below into a space that is present between the two second deflection rollers, on account of which the second contact pressure belt is deflected by the third grooving roller. The second contact pressure belt presses against the continuous second cover web which in turn is pressed against the continuous second corrugated web that is provided with glue and bears on the third grooving roller.

In order for the second corrugated cardboard web 17 laminated on one side to be further conveyed, said second corrugated cardboard web 17 laminated on one side is fed to the bridge 15 by way of a second elevated transportation installation 26. The bridge 15 can also serve for the intermediate storage and buffer storage of the second corrugated cardboard web 17 laminated on one side.

The corrugated cardboard plant furthermore has a lamination web splicing device 27 which is configured like the other splicing devices 6, 7, 18, and 19, respectively. The lamination web splicing device 27 comprises a ninth unwinding unit for unwinding a finite first lamination web from a first lamination web roll 28, and a tenth unwinding unit for unwinding a finite second lamination web from a second lamination web roll 29. The finite first lamination web and the finite second lamination web are connected to one another in the lamination web splicing device 27 in order for a continuous lamination web 30 to be provided. The continuous lamination web 30 is single-ply.

A lamination web printing assembly 31 for imprinting the lamination web 30, in terms of the lamination web 30, is disposed downstream to the lamination web splicing device 27.

The lamination web printing assembly 31 comprises a corona pre-treatment device 32 which is disposed on the entry side, or so as to be adjacent to the lamination web splicing device 27, respectively. The corona pre-treatment device 32 stands on a floor or a hard surface, respectively. Said corona pre-treatment device 32 comprises a corona support roller 33 and at least one electrode 34 that is disposed so as to be adjacent to the latter. The corona support roller 33 extends horizontally and perpendicularly to a conveying direction 3 of the continuous lamination web 30. The continuous lamination web 30 is guided around the corona support roller 33. The continuous lamination web 30 herein runs through a gap which is formed or delimited, respectively, by the corona support roller 33 and by the at least one electrode 34. The continuous lamination web 30, on account of the corona pre-treatment device 32, is exposed to an electric corona discharge, this leading to an oxidation of the surface of said continuous lamination web 30, in particular on the print side. This results in a comparatively high increase in pixels in a later application of paint or in later imprinting, respectively. The adhesion of a printing ink on the continuous lamination web 30 can thus be improved.

The lamination web printing assembly 31 moreover has a pre-coating application device 35 which in terms of the continuous lamination web 30 is disposed downstream of the corona pre-treatment device 32 and stands on a floor or a hard surface, respectively. The pre-coating application device 35 is assigned to the continuous lamination web 30 and is capable of applying a planar pre-coating to an external side, or print side 36, respectively, of the continuous lamination web 30. To this end, the pre-coating application device 35 favourably utilizes at least one pre-coating roller which extends horizontally and perpendicularly to the conveying direction 3 of the continuous lamination web 30. The at least one pre-coating roller is preferably submerged in a pre-coating means that is capable of being applied.

The lamination web printing assembly 31 furthermore has a pre-coating drying device 37 which in terms of the continuous lamination web 30 is disposed downstream of the pre-coating application device 35 and dries the pre-coating, or the continuous lamination web 30, respectively, on the external side. The pre-coating drying device 37 runs horizontally. Said pre-coating drying device 37 is disposed above the corona pre-treatment device 32 and the pre-coating application device 35. The pre-coating drying device 37 favourably has pre-coating drying installations which are disposed behind one another, or in series, respectively.

The lamination web printing assembly 31, in terms of the continuous lamination web 30 downstream of the pre-coating drying device 37, has a pivot roller 38 which forms a lamination web run correction installation and is disposed so as to be adjacent to the pre-coating drying device 37. The continuous lamination web 30 is guided around the pivot roller 38. The pivot roller 38 extends in a transverse direction, or a width direction, respectively, of the continuous lamination web 30. Said pivot roller 38 preferably runs horizontally. The angle of the pivot roller 38 in relation to the continuous lamination web 30, or to the conveying direction 3 thereof, respectively, is variable, this leading to a corresponding lateral deflection of the conveyed continuous lamination web 30.

The lamination web printing assembly 31 moreover has an ink jet printing device 39 which in terms of the continuous lamination web 30 is disposed downstream of the pivot roller 38. The ink jet printing device 39 is assigned to the continuous lamination web 30 and is capable of imprinting at least one imprint on the continuous lamination web 30, or on the dried pre-coating, respectively, on the external side. The pre-coating is thus located between the at least one imprint and the continuous lamination web 30. The at least one imprint is favourably a colour imprint. Said at least one imprint is located on the print side of the continuous lamination web 30.

The ink jet printing device 39 comprises a central cylinder 40 which extends perpendicularly to the conveying direction 3 of the lamination web 30, and horizontally. The ink jet printing device 39 furthermore has an ink jet printing bar 41 having printing heads which ink jet printing bar 41 in regions extends about the central cylinder 40 so as to be spaced apart while forming a printing gap 42. The continuous lamination web 30, in order to be imprinted on the external side, is guided through the printing gap 42.

The ink jet printing device 39 is at least largely disposed in a housing-type heat-protection assembly 43. The ink jet printing bar 41 is in particular completely accommodated in the heat-protection assembly 43. The central cylinder 40 is preferably at least largely accommodated in the heat-protection assembly 43. Said heat-protection assembly 43 extends horizontally.

The lamination web printing assembly 31 moreover has an infra-red drying device 44 which in terms of the continuous lamination web 30 is disposed downstream of the ink jet printing device 39 and is assigned to the continuous lamination web 30. The infra-red drying device 44 extends horizontally and dries the imprinted continuous lamination web 30, or the at least one imprint of the latter, respectively, by means of infra-red radiation. The infra-red drying device 44 is disposed below the ink jet printing device 39, or the heat-protection assembly 43, respectively, and so as to be adjacent thereto.

A hot air drying device 45 of the lamination web printing assembly 31 in terms of the continuous lamination web 30 is disposed downstream of the infra-red drying device 44, said hot air drying device 45 being assigned to the continuous lamination web 30 and further drying the already somewhat dried continuous lamination web 30, or the already somewhat dried imprint thereof, respectively, by means of hot air. The hot air drying device 45 extends vertically and so as to be adjacent to the ink jet printing device 39, or to the heat-protection assembly 43, respectively. Said hot air drying device 45 is directly downstream of the infra-red drying device 44.

The lamination web printing assembly 31 favourably has a multiplicity of deflection rollers in order for the continuous lamination web 30 to be guided between the individual components of the lamination web printing assembly 31.

The corrugated cardboard plant, downstream of the hot air drying device 45, has a re-humidification device 46 which is assigned to the continuous lamination web 30 and which from above humidifies said continuous lamination web 30 opposite to the print side 36.

The lamination web printing assembly 31 is disposed below the bridge 15. The bridge 15 has a support assembly 48 that runs so as to be vertically spaced apart from the hard surface 47 and so as to be parallel with the latter. The support assembly 48 extends horizontally and determines a bridge height level. Said support assembly 48 runs above the splicing devices 6, 7, 18, 19, 27 and the devices 4, 16 for producing corrugated cardboard webs 5, 17 laminated on one side, and is supported in relation to said devices.

The bridge 15 has a first elevated assembly 49 which in relation to the support assembly 48 is elevated on a frame and preferably extends above the second heating assembly 24, the second device 16 for producing a second corrugated cardboard web 17 laminated on one side, the second material web splicing device 19, and the lamination web splicing device 27, as well as the lamination web printing assembly 31. The first corrugated cardboard web 5 laminated on one side is conveyed on the first elevated assembly 49. The first corrugated cardboard web 5 laminated on one side therein is first conveyed upwards and then horizontally. The first elevated assembly 49 can also be configured in another manner, in particular so as to be longer or shorter.

The bridge 15 furthermore has a second elevated assembly 50 which in relation to the support assembly 48 is elevated on a frame and runs below the first elevated assembly 49. The second elevated assembly 50 preferably extends above the second material web splicing device 19 and the lamination web splicing device 27 as well as the lamination web printing assembly 31. The second corrugated cardboard web 17 laminated on one side is conveyed on the second elevated assembly 50. The second corrugated cardboard web 17 laminated on one side therein is first conveyed upwards and then horizontally. The second elevated assembly 50 can also be configured in another manner, in particular so as to be longer or shorter.

The lamination web printing assembly 31 is disposed below the first elevated assembly 49 as well as below the second elevated assembly 50 of the bridge 15. The pre-coating drying device 37 is completely disposed above the support assembly 48. The ink jet printing bar 41 and the hot air drying device 45 partially extend above the support assembly 48. The corona pre-treatment device 32, the pre-coating application device 35, the central cylinder 40, the infra-red drying device 44, and the re-humidification device 46 extend below the support assembly 48 of the bridge 15.

A web run correction assembly 51, which comprises a first web run correction device 52 assigned to the first corrugated cardboard web 5 laminated on one side, and a second web run correction device 53 assigned to the second corrugated cardboard web 17 laminated on one side, is disposed in a downstream end region on the bridge 15, or on the elevated assemblies 49, 50, respectively. The first web run correction device 52 is capable of influencing a web run of the first corrugated cardboard web 5 laminated on one side, or to cause a transverse deflection of the latter, respectively. The second web run correction device 53 is capable of influencing a web run of the second corrugated cardboard web 17 laminated on one side, or to cause a transverse deflection of the latter, respectively.

The web run correction assembly 51 is disposed above the hot air drying device 45 and the re-humidification device 46. Said web run correction assembly 51 in the conveying direction 3 is offset in relation to the lamination web printing assembly 31.

A gluing unit 54 of the corrugated cardboard plant is disposed downstream of the web run correction assembly 51 and of the re-humidification device 46. The gluing unit 54 follows directly downstream of the web run correction assembly 51 and the re-humidification device 46. A horizontal spacing between the lamination web printing assembly 31, or the ink jet printing device 39, respectively, and the gluing unit 54 is extremely minor, in particular smaller than 5 m. In particular, a pre-heating assembly which otherwise is disposed upstream of the gluing unit 54, as is known, in order for the corrugated cardboard webs 5, 17 laminated on one side, and the continuous lamination web 30, to be pre-heated prior to being glued or adhesively bonded, respectively, to one another, is absent. The continuous lamination web 30 is already sufficiently heated by the active ink jet printing device 39.

The gluing unit 54 has a first gluing roller which is partially submerged into a first glue bath. The first corrugated cardboard web 5 laminated on one side, by way of the corrugated web thereof, is in contact with the first gluing roller and is thus provided with glue from the first glue bath. A first metering roller bears circumferentially on the first gluing roller so as to configure a uniform glue film on the first gluing roller.

The gluing unit 54 furthermore has a second gluing roller which is partially submerged into a second glue bath. The second corrugated cardboard web 17 laminated on one side, by way of the corrugated web thereof, is in contact with the second gluing roller and is thus provided with glue from the second glue bath. A second metering roller bears circumferentially on the second gluing roller so as to configure a uniform glue film on the second gluing roller.

The continuous lamination web 30 in the gluing unit 54 runs below the corrugated cardboard webs 5, 17 laminated on one side.

The corrugated cardboard plant, downstream of the gluing unit 54, has a compression device 55 which comprises an upper compression belt that is guided over upper guide rollers, and a lower compression belt that is guided over lower guide rollers. A lower belt of the upper compression belt and an upper belt of the lower compression belt run in a horizontal and mutually adjacent manner. Said lower belt of the upper compression belt and said upper belt of the lower compression belt configure a compression section. The glued corrugated cardboard webs 5, 17 laminated on one side and the continuous lamination web 30 are guided through the compression section. The continuous corrugated cardboard web 1 which is laminated on two sides and has a total of five plies is formed in the compression device 55, while the glue bonds or cures, respectively.

The corrugated cardboard plant, downstream of the compression device 55, has a short transverse cutting device 56 which comprises a knife cylinder and a counter cylinder disposed below the latter. The knife cylinder and the counter cylinder are mounted so as to be rotatable or drivable in a rotating manner, respectively. The short transverse cutting device 56 is capable of generating a cut which extends across the full width of the continuous corrugated cardboard web 1. To this end, the knife cylinder and the counter cylinder are set in rotation in such a manner that said knife cylinder and said counter cylinder interact with each other in the cutting procedure. The short transverse cutting device 56 is furthermore capable of generating a cut having a specific length and a specific spacing from a longitudinal periphery of the continuous corrugated cardboard web 1. To this end, counter-member elements of the counter cylinder are chosen or adjusted in a corresponding manner, respectively. The knife cylinder and the counter cylinder are set in rotation for the cutting procedure in such a manner that a knife of the knife cylinder interacts with the counter-member elements.

The corrugated cardboard plant, downstream of the short transverse cutting device 56, has a longitudinal cutting/grooving device 57 having two grooving units and two longitudinal cutting units disposed downstream of the latter. The longitudinal cutting units are capable of cutting the continuous corrugated cardboard web 1 in the longitudinal direction 3 while forming corrugated cardboard part-webs. The grooving units are capable of grooving the continuous corrugated cardboard web 1 in order for any later folding to be simplified.

The short transverse cutting device 56 is alternatively disposed downstream of the longitudinal cutting/grooving device 57.

A turnout 58 of the corrugated cardboard plant is provided downstream of the longitudinal cutting/grooving device 57, said turnout 58 being provided for splitting the generated corrugated cardboard part-webs in two different planes.

A transverse cutting device 59 having two partial transverse cutting installations 60, 61 disposed on top of one another is provided downstream of the turnout 58. Each partial transverse cutting installation 60, 61 has two transverse cutting rollers that are drivable in a rotating manner and disposed on top of one another, said transverse cutting rollers extending perpendicularly to the conveying direction 3 and having transverse cutting knives that extend radially outwards in order for the respective corrugated cardboard part-web to be completely severed in a transverse manner, while generating corrugated cardboard sheets.

A conveyor belt on which the corrugated cardboard sheets imprinted on the external side are guided to form a respective stack deposit 62 or 63, respectively is disposed downstream of each partial transverse cutting installation 60, 61.

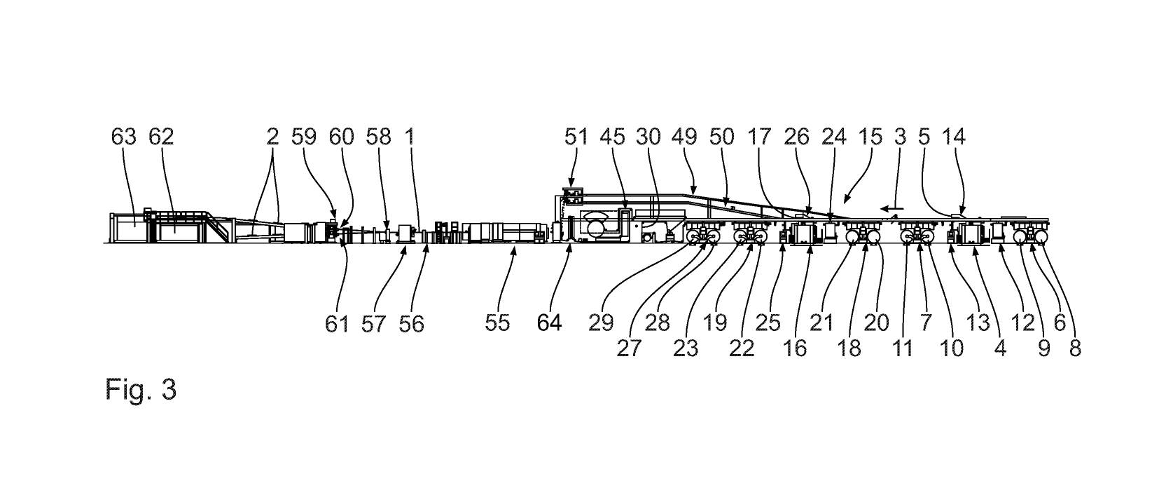

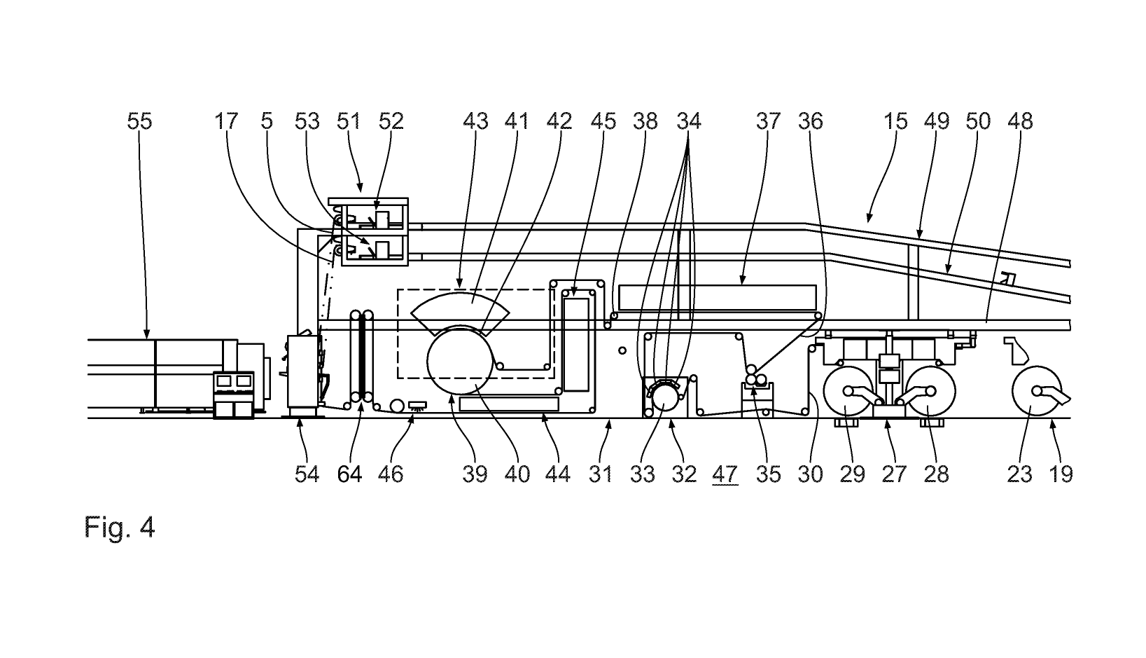

A second embodiment will be described hereunder with reference to FIGS. 3, 4. As compared to the first embodiment, reference to the description thereof herewith being explicitly made, the lamination web printing assembly 31 is of a different constructive design. While the sequence of the corona pre-treatment device 32, the pre-coating application device 35, the pre-coating drying device 37, the ink jet printing device 39, the infra-red drying device 44, and the hot air drying device 45 is identical, said devices are however placed differently in the corrugated cardboard plant. The guiding of the continuous lamination web 30 in the lamination web printing assembly 31 is also different.

The re-humidification device 46 is again disposed downstream of the infra-red drying device 44. A reversing bar assembly 64 which is disposed below the web run correction assembly 51 and is disposed upstream of the gluing unit 54, in terms of the continuous lamination web 30 is disposed downstream of the re-humidification device 46. The continuous lamination web 30 is guided around reversing bars of the reversing bar assembly 64 in such a manner that the print side 36 of the continuous lamination web 30 downstream of the reversing bar assembly 64 is directed downwards. Prior thereto, the print side 36 is directed upwards.

What is claimed is:

1. A corrugated cardboard plant for producing corrugated cardboard, comprising
a) at least one device (4, 16) for producing a respective corrugated cardboard web (5, 17) laminated on one side from a respective cover web and a respective material web;
b) a lamination web dispensing device (27) for dispensing a lamination web (30);
c) a lamination web printing assembly (31), disposed downstream of the lamination web dispensing device (27), for imprinting the lamination web (30); and
d) a device (55), disposed downstream of the lamination web printing assembly (31), for producing a corrugated cardboard web (1) laminated on two sides from the at least one corrugated cardboard web (5, 17) laminated on one side and the lamination web (30).

2. The corrugated cardboard plant according to claim 1, wherein the at least one device (4, 16) for producing a respective corrugated cardboard web (5, 17) laminated on one side, and the lamination web dispensing device (27), and the lamination web printing assembly (31) are disposed in one row.

3. The corrugated cardboard plant according to claim 2, wherein the at least one device (4, 16) for producing a respective corrugated cardboard web (5, 17) laminated on one side, and the lamination web dispensing device (27), and the lamination web printing assembly (31) are disposed in one row in a conveying direction (3) of the corrugated cardboard plant.

4. The corrugated cardboard plant according to claim 1, wherein the lamination web printing assembly (31) is disposed below a bridge (15) for guiding the at least one corrugated cardboard web (5, 17) laminated on one side in a direction towards the device (55) for producing a corrugated cardboard web (1) laminated on two sides.

5. The corrugated cardboard plant according to claim 4, wherein the bridge (15) comprises at least one shield assembly for reducing a drying-up of the at least one corrugated cardboard web (5, 17) laminated on one side that is guided in the bridge (15).

6. The corrugated cardboard plant according to claim 5, wherein the at least one shield assembly comprises at least one of the group comprising at least one side wall and at least one cover.

7. The corrugated cardboard plant according to claim 1, wherein a bridge (15) has a web run correction assembly (51) for correcting a web run of the at least one corrugated cardboard web (5, 17) laminated on one side in the bridge (15), wherein the web run correction assembly (51) has a smaller horizontal spacing from the device (55) for producing a corrugated cardboard web (1) laminated on two sides than the lamination web printing assembly (31).

8. The corrugated cardboard plant according to claim 1, comprising a reversing assembly (64) for directing a print side (36) of the lamination web (30) downwards, wherein the reversing assembly (64) is disposed downstream of the lamination web printing assembly (31) and upstream of the device (55) for producing a corrugated cardboard web (1) laminated on two sides.

9. The corrugated cardboard plant according to claim 8, wherein the reversing assembly (64) has at least one vertically running reversing bar.

10. The corrugated cardboard plant according to claim 9, wherein the vertically running reversing bar is horizontally displaceable for correcting a web run of the lamination web (30).

11. The corrugated cardboard plant according to claim 1, comprising at least one re-humidification device (46) for re-humidifying the lamination web (30), wherein the re-humidification device (46) is disposed downstream of the lamination web printing assembly (31) and upstream of the device (55) for producing a corrugated cardboard web (1) laminated on two sides.

12. The corrugated cardboard plant according to claim 1, comprising a gluing unit (54) for gluing the at least one corrugated cardboard web (5, 17) laminated on one side with glue, wherein the gluing unit (54) is disposed downstream of the lamination web printing assembly (31) and adjacent to the lamination web printing assembly (31).

13. The corrugated cardboard plant according to claim 12, wherein the gluing unit (54) is disposed directly adjacent to the lamination web printing assembly (31).

14. The corrugated cardboard plant according to claim 12, wherein the gluing unit (54) is disposed so that the lamination web printing assembly (31) heats the lamination web (30) in such a manner that the glue applied by the gluing unit (54) bonds.

15. The corrugated cardboard plant according to claim 12, wherein the glue used in the gluing unit (54) permits processing temperatures of below 70° C.

16. The corrugated cardboard plant according to claim 1, wherein the lamination web printing assembly (31) heats the lamination web (30) in such a manner that said lamination web (30) in the device (55) for producing a corrugated cardboard web (1) laminated on two sides is connectable in a glued manner to the adjacent corrugated cardboard web (17) laminated on one side.

17. The corrugated cardboard plant according to claim 1, comprising at least one heat protection assembly (43) for protecting a lamination printing device (41) of the lamination web printing assembly (31) against thermal input.

18. The corrugated cardboard plant according to claim 1, comprising a lamination web run correction installation (38) for correcting a web run of the lamination web (30).

19. The corrugated cardboard plant according to claim 18, wherein the lamination web run correction installation (38) comprises at least one pivotable pivot roller.

20. The corrugated cardboard plant according to claim 18, wherein the web run correction installation (38) is disposed downstream of a pre-coating application device (35).

21. A method for producing corrugated cardboard, comprising the step of
applying glue by means of a gluing unit (54) to free tips of at least one corrugated cardboard web (5, 17) laminated on one side for connecting the latter in a glued manner to a further web (17, 5, 30) for forming a corrugated cardboard web (1) laminated on two sides, wherein the glue permits processing temperatures of below 70° C.

22. The method for producing corrugated cardboard according to claim 21, wherein said processing temperatures of below 70° C. are present at least on one of the group comprising the at least one corrugated cardboard web (5, 17) laminated on one side and the lamination web (30).
